(19) United States
(12) Patent Application Publication
(10) Pub. No.: US 2023/0090619 A1
(43) Pub. Date: Mar. 23, 2023

(54) OPTICAL DEVICE AND OPTICAL COMMUNICATION APPARATUS

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 17/882,147

(22) Filed: Aug. 5, 2022

(30) Foreign Application Priority Data
Sep. 22, 2021 (JP) 2021-153815

(51) Int. Cl. G02F 1/01

(52) U.S. Cl. CPC G02F 1/0147; G02F 1/011; H04B 10/548

(57) ABSTRACT

An optical device includes a substrate, a dielectric substance laminated on the substrate, an optical waveguide surrounded by the dielectric substance, a heater electrode that is disposed above the optical waveguide and that is surrounded by the dielectric substance, and a trench. The trench includes a plurality of split trenches each of which is formed in a hollow segmented shape in the dielectric substance and in which the split trenches are disposed in parallel with the heater electrode. The split trenches are disposed in parallel with the heater electrode such that an area of the dielectric substance located between an end of each of the split trenches and a side surface of the heater electrode is gradually expanded.

### CROSS-REFERENCE TO RELATED APPLICATION

This application is based upon and claims the benefit of priority of the prior Japanese Patent Application No. 2021-153815, filed on Sep. 22, 2021, the entire contents of which are incorporated herein by reference.

### FIELD

The embodiments discussed herein are related to an optical device and an optical communication apparatus.

### BACKGROUND

Phase shifter are built into an optical modulator and an optical receiver that are included in an optical communication apparatus used for high-speed optical communication. Each of the phase shifters raises the temperature inside an optical waveguide using heater heat and the refractive index in the interior of the optical waveguide caused by the temperature rise is changed accordingly, so that each of the phase shifters shifts, in accordance with a change in the refractive index, the phase of the signal light passing through the optical waveguide.

FIG. 17 is a schematic plan view illustrating an example of a phase shifter 200 that is conventionally used, and FIG. 18 is a schematic cross-sectional diagram taken along line G-G of the phase shifter 200 illustrated in FIG. 17. The phase shifter 200 illustrated in FIG. 17 includes a Si substrate 201, a dielectric substance 202, an optical waveguide 203, a heater electrode 204, and electrode pad 205. The dielectric substance 202 is laminated on the Si substrate 201 and surrounds the circumference of the optical waveguide 203 that is disposed above the Si substrate 201 and the circumference of the heater electrode 204 that is disposed above the optical waveguide 203.

The dielectric substance 202 is made of, for example, SiO₂ or the like. The optical waveguide 203 is a waveguide that is made of, for example, Si and through which signal light passes. The heater electrode 204 is made of, for example, metal, such as Ti, having a resistance property, generates heater heat in accordance with a drive current, and raises temperature in the interior of the optical waveguide 203. The electrode pad 205 is connected to the heater electrode 204, and includes an input side electrode pad 205A that inputs an electric current to the heater electrode 204, and an output side electrode pad 205B that outputs the electric current from the heater electrode 204.

The phase shifter 200 raises the temperature in the interior of the optical waveguide 203 by the heater heat that is generated in accordance with the drive current that is output to the heater electrode 204. Furthermore, in the optical waveguide 203, the refractive index inside the optical waveguide 203 is changed in accordance with the thermo-optical effect of Si caused by the temperature rise. In addition, the phase shifter 200 shifts the phase of the signal light passing through the interior of the optical waveguide 203 in accordance with a change in the refractive index.

In the phase shifter 200 illustrated in FIG. 17, a great portion the heater heat generated in the heater electrode 204 becomes diffuse to the dielectric substance 202 and the Si substrate 201, only a fraction of the heater heat acts on the optical waveguide 203. As a result, heating efficiency with respect to the optical waveguide 203 is degraded, and thus, electric power consumption is increased.

Accordingly, there is a phase shifter that improves the heating efficiency with respect to the optical waveguide 203. FIG. 19 is a schematic plan view illustrating an example of a phase shifter 200A that is conventionally used, and FIG. 20 is a schematic cross-sectional diagram taken along line H-H of the phase shifter 200A illustrated in FIG. 19. In addition, by assigning the same reference numerals to components having the same configuration and operation as those in the phase shifter 200 illustrated in FIG. 17, overlapped descriptions of the configuration and the operation thereof will be omitted.

The phase shifter 200A illustrated in FIG. 19 includes, in addition to the Si substrate 201, the dielectric substance 202, the optical waveguide 203, the heater electrode 204, and the electrode pad 205, a hollow portion 206 and two trenches 207 (207A and 207B). The hollow portion 206 is constituted by a hollow that is formed in a region of the Si substrate 201 on which the dielectric substance 202 located below the optical waveguide 203 is laminated. Each of the trenches 207 is constituted by a hollow that is formed in the dielectric substance 202 that surrounds the circumferences of the heater electrode 204 and the optical waveguide 203. Each of the trenches 207 is disposed in parallel so as to sandwich the left and right side surfaces of the heater electrode 204 that is disposed inside the dielectric substance 202 and that is disposed above the optical waveguide 203.

Each of the trenches 207 is constituted such that a hollow is formed in the region of the dielectric substance 202 that is disposed in parallel with the heater electrode 204, thereby suppressing diffusion of the heater heat generated in the heater electrode 204 to the dielectric substance 202. The hollow portion 206 suppresses diffusion of the heater heat generated in the heater electrode 204 to the Si substrate 201. In other words, by using the two trenches 207 and the hollow portion 206, the phase shifter 200A suppresses diffusion of the heater heat generated in the heater electrode 204 to the dielectric substance 202 or the Si substrate 201 that is other than the optical waveguide 203. As a result, it is possible to suppress electric power consumption of the phase shifter 200A while improving the heating efficiency with respect to the optical waveguide 203.

However, with the conventional phase shifter 200A, the dielectric substance 202 that covers the optical waveguide 203 by the two trenches 207 and the hollow portion 206 is in a floating state in the air above the Si substrate 201. In addition, a size L of the phase shifter 200A is about several hundred microns, so that stress is concentrated in regions X that are located on both ends of the trench 207 associated with the dielectric substance 202 and the optical waveguide 203 caused by the hollows of the two trenches 207 and the hollow portion 206. If the stress is concentrated in the regions X of the dielectric substance 202 and the optical waveguide 203 that are located on both ends of the trench 207, a crack occurs in the region X. As a result, an optical loss in the optical waveguide 203 is increased due to the occurrence of the crack in the region X.

Accordingly, there is a demand for a phase shifter 200B that is able to suppress an occurrence of a crack of the optical waveguide 203 while improving the heating efficiency of the optical waveguide.

FIG. 21 is a schematic plan view illustrating an example of the conventional phase shifter 200B, FIG. 22 is a schematic cross-sectional diagram taken along line J-J of the phase shifter 200B illustrated in FIG. 21, and FIG. 23 is a schematic cross-sectional diagram taken along line K-K of the phase shifter 200B illustrated in FIG. 21. In addition, by assigning the same reference numerals to components having the same configuration and operation as those in the phase shifter 200A illustrated in FIG. 19, overlapped descriptions of the configuration and the operation thereof will be omitted.

The phase shifter 200B illustrated in FIG. 21 includes the two trenches 207, each of which includes a plurality of split trenches 210 formed in a segmented shape, and bridges 202B that are formed of the dielectric substance 202 and that connect the split trenches 210. The trench 207A corresponding to one of the trenches 207 includes the four split trenches 210 each having, for example, a plane rectangular shape with the same size.

Similarly, the trench 207B corresponding to the other of the trenches 207 also includes the four split trenches 210.

In the phase shifter 200B, the trenches 207 are constituted from the plurality of split trenches 210, concentration of the stress applied to the plurality of bridges 202B is dispersed between the split trenches 210. As a result, as compared to the phase shifter 200A illustrated in FIG. 19, it is possible to suppress an occurrence of the optical loss in the optical waveguide 203 by suppressing concentration of the stress due to the hollows by suppressing an occurrence of the crack in the region X.

Patent Document 1: Japanese Laid-open Patent Publication No. 01-158413

Patent Document 2: Japanese Laid-open Patent Publication No. 2016-142995

Patent Document 3: Japanese Laid-open Patent Publication No. 2004-037524

Patent Document 4: U.S. Pat. No. 5,117,470

With the conventional phase shifter 200B, an area of a region 202A of the dielectric substance 202 located between the split trenches 210 and the heater electrode 204 is decreased, so that the heater heat of the heater electrode 204 is concentrated in the region 202A and thus the temperature is locally increased. In contrast, with the phase shifter 200B, the area of the bridges 202B formed of the dielectric substance 202 located between the split trenches 210 is expanded, so that the heater heat of the heater electrode 204 is diffused and the temperature is decreased accordingly.

However, with the conventional phase shifter 200B, the heater heat of the heater electrode 204 is diffused in the bridges 202B located between the split trenches 210, so that, if a large electric current flows in the heater electrode 204, the temperature gradient is sharp between the bridge 202B and the region 202A. If the temperature gradient is sharp between the bridge 202B and the region 202A, the material (Ti) of the heater electrode 204 mutates due to thermo-migration, and thus, breakage of the heater electrode 204 may possibly occur. As a result, long-term reliability of the phase shifter 200B is degraded.

### SUMMARY

According to an aspect of an embodiment, an optical device includes a substrate, a dielectric substance that is laminated on the substrate, an optical waveguide that is surrounded by the dielectric substance, a heater electrode that is disposed above the optical waveguide and that is surrounded by the dielectric substance, and a trench. The trench includes a plurality of split trenches each of which is formed in a hollow segmented shape in the dielectric substance and in which the split trenches are disposed in parallel with the heater electrode. The split trenches are disposed in parallel with the heater electrode such that an area of the dielectric substance located between an end of each of the split trenches and a side surface of the heater electrode is gradually expanded.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an optical communication apparatus according to an embodiment;

FIG. 2 is a schematic plan view illustrating an example of a phase shifter according to a first embodiment;

FIG. 3 is a schematic cross-sectional diagram taken along line A-A of the phase shifter illustrated in FIG. 2;

FIG. 4 is a schematic cross-sectional diagram taken along line B-B of the phase shifter illustrated in FIG. 2;

FIG. 5 is a schematic plan view illustrating an example of a phase shifter according to a second embodiment;

FIG. 6 is a schematic plan view illustrating an example of a phase shifter according to a third embodiment;

FIG. 7 is a schematic plan view illustrating an example of a phase shifter according to a fourth embodiment;

FIG. 8 is a schematic plan view illustrating an example of a phase shifter according to a fifth embodiment;

FIG. 9 is a schematic cross-sectional diagram taken along line C-C of the phase shifter illustrated in FIG. 8;

FIG. 10 is a schematic cross-sectional diagram taken along line D-D of the phase shifter illustrated in FIG. 8;

FIG. 11 is a schematic plan view illustrating an example of a phase shifter according to a sixth embodiment;

FIG. 12 is a schematic plan view illustrating an example of a phase shifter according to a seventh embodiment;

FIG. 13 is a schematic plan view illustrating an example of a phase shifter according to an eighth embodiment;

FIG. 14 is a schematic plan view illustrating an example of a phase shifter according to a ninth embodiment;

FIG. 15 is a schematic cross-sectional diagram taken along line E-E of the phase shifter illustrated in FIG. 14;

FIG. 16 is a schematic cross-sectional diagram taken along line F-F of the phase shifter illustrated in FIG. 14;

FIG. 17 is a schematic plan view illustrating an example of a conventional phase shifter;

FIG. 18 is a schematic cross-sectional diagram taken along line G-G of the phase shifter illustrated in FIG. 17;

FIG. 19 is a schematic plan view illustrating an example of a conventional phase shifter;

FIG. 20 is a schematic cross-sectional diagram taken along line H-H of the phase shifter illustrated in FIG. 19;

FIG. 21 is a schematic plan view illustrating an example of a conventional phase shifter;

FIG. 22 is a schematic cross-sectional diagram taken along line J-J of the phase shifter illustrated in FIG. 21; and

FIG. 23 is a schematic cross-sectional diagram taken along line K-K of the phase shifter illustrated in FIG. 21.

### DESCRIPTION OF EMBODIMENTS

Preferred embodiments of the present invention will be explained with reference to accompanying drawings. Furthermore, the present invention is not limited to the embodiments. In addition, the embodiments described below may also be used in any appropriate combination as long as the embodiments do not conflict with each other.

### [a] First Embodiment

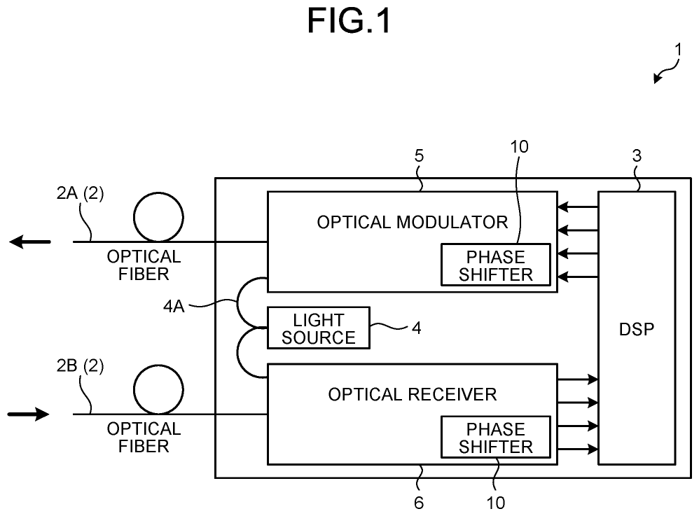

FIG. 1 is a diagram illustrating an example of an optical communication apparatus 1 according to an embodiment. The optical communication apparatus 1 illustrated in FIG. 1 is connected to an optical fiber 2A (2) associated with an output side and an optical fiber 2B (2) associated with an input side. The optical communication apparatus 1 includes a digital signal processor (DSP) 3, a light source 4, an optical modulator 5, and an optical receiver 6. The DSP 3 is an electrical component that performs digital signal processing. The DSP 3 performs a process of, for example, encoding transmission data or the like, generates an electrical signal including the transmission data, and outputs the generated electrical signal to the optical modulator 5. Furthermore, the DSP 3 acquires an electrical signal including reception data from the optical receiver 6 and obtains reception data by performing a process of, for example, decoding the acquired electrical signal.

The light source 4 includes, for example, a laser diode or the like, generates light with a predetermined wavelength, and supplies the generated light to the optical modulator 5 and the optical receiver 6. The optical modulator 5 is an optical device that modulates, by using the electrical signal output from the DSP 3, the light supplied from the light source 4 and that outputs the obtained optical transmission signal to the optical fiber 2A. The optical modulator 5 is an optical modulator or the like that includes phase shifters 10 or the like. The optical modulator 5 generates an optical transmission signal by modulating, when the light supplied from the light source 4 propagates through the waveguide, the light by using the electrical signal that is input to the modulating unit. The phase shifter 10 shifts the phase of the signal light that passes through the optical waveguide.

The optical receiver 6 receives the optical signal from the optical fiber 2B and demodulates the received optical signal by using the light that is supplied from the light source 4. Then, the optical receiver 6 converts the demodulated received optical signal to an electrical signal and outputs the converted electrical signal to the DSP 3. Furthermore, the optical receiver 6 also includes the phase shifter 10.

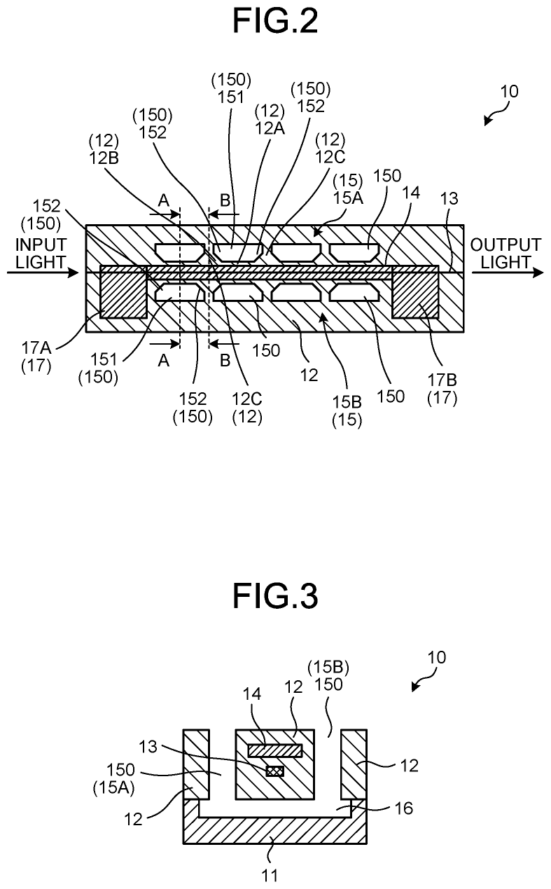

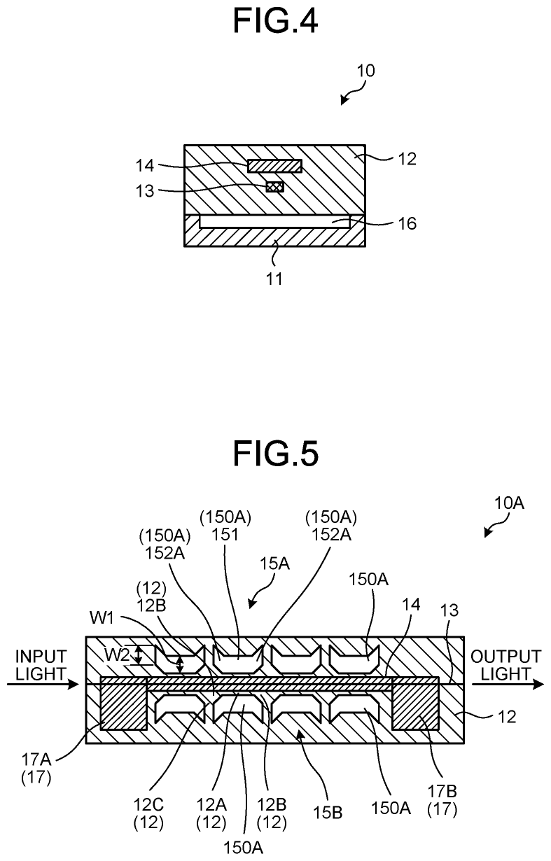

FIG. 2 is a schematic plan view illustrating an example of the phase shifter 10 according to the first embodiment, FIG. 3 is a schematic cross-sectional diagram taken along line A-A of the phase shifter 10 illustrated in FIG. 2, and FIG. 4 is a schematic cross-sectional diagram taken along line B-B of the phase shifter 10 illustrated in FIG. 2. The phase shifter 10 illustrated in FIG. 2 includes a Si substrate 11, a dielectric substance 12, an optical waveguide 13, a heater electrode 14, two trenches 15 (15A and 15B), a hollow portion 16, and an electrode pad 17.

The dielectric substance 12 is laminated on the Si substrate 11 and surrounds the circumference the optical waveguide 13 disposed above the Si substrate 11 and the circumference of the heater electrode 14 disposed above the optical waveguide 13. The dielectric substance 12 is made of, for example, SiO₂ or the like. The optical waveguide 13 inside the dielectric substance 12 is a waveguide that is made of, for example, Si, and through which signal light passes. The heater electrode 14 inside the dielectric substance 12 is made of, for example, metal having a resistance property, such as Ti, generates heat of a heater in accordance with a drive current, and raise the temperature in the interior of the optical waveguide 13 by using the heat of a heater. The electrode pad 17 includes an input side electrode pad 17A that inputs an electric current to the heater electrode 14, and an output side electrode pad 17B that outputs the electric current from the heater electrode 14. The hollow portion 16 is constituted by a hollow that is formed in a region of the Si substrate 11 on which the dielectric substance 12 that covers the lower part of the optical waveguide 13 is laminated.

Each of the trenches 15 includes a plurality of split trenches 150 each of which has a hollow segmented shape and is formed in a region of the dielectric substance 12 and that is disposed in parallel with the heater electrode 14. Furthermore, the two trenches 15 are trenches that are disposed in parallel with the dielectric substance 12 located on the left and right side surfaces of the heater electrode 14. The two trenches 15 corresponds to a first trench 15A and a second trench 15B. The first trench 15A includes the four split trenches 150 each having a substantially fan shape with the same size. Similarly, the second trench 15B also includes the four split trenches 150 with the same size.

Each of the split trenches 150 includes a central part 151 that corresponds to a middle portion of each of the split trenches 150 and leading end portions 152 that correspond to both end portions of each of the split trenches 150. Each of the leading end portions 152 is a trench that has a substantially fan shape and in which the trench width is gradually decreased from the central part 151 toward the leading end portion 152. Furthermore, each of the leading end portions 152 is a trench in which the distance from the leading end portion 152 to the optical waveguide 13 is continuously changed. The dielectric substance 12 includes a first region 12A that is a region located between the central part 151 included in each of the split trenches 150 and the heater electrode 14 and a second region 12B that is a region located between the leading end portions 152 included in the respective split trenches 150 and the heater electrode 14. In addition, the dielectric substance 12 includes a bridge 12C that corresponds to a region located between the split trenches 150. The first region 12A corresponds to a region of the dielectric substance 12 located between a wall surface of the central part 151 on the heater electrode 14 side and the side surface of the heater electrode 14. The second region 12B corresponds to a region of the dielectric substance 12 located between the wall surface of each of the leading end portions 152 on the heater electrode 14 side and the side surface of the heater electrode 14. The bridge 12C corresponds to a region of the dielectric substance 12 located between the adjacent split trenches 150.

A trench width W2 of each of the leading end portions 152 included in the respective split trenches 150 is made continuously narrower than a trench width W1 of the central part 151, so that the width of the second region 12B included in the dielectric substance 22 located between the leading end portions 152 and the heater electrode 14 is gradually wider. Accordingly, in the second region 12B, temperature is decreased caused by the heater heat of the heater electrode 14 from being diffused. As a result, by reducing the inclination of the temperature gradient between the bridge 12C and the second region 12B between the split trenches 150, it is possible to suppress the material of the heater electrode 14 from varying caused by thermo-migration.

In the phase shifter 10, concentration of stress is dispersed at the plurality of bridges 12C between the split trenches 150. As a result, as compared to the phase shifter 200B illustrated in FIG. 19, it is possible to suppress an occurrence of a crack of the optical waveguide 13 by suppressing the concentration of the stress caused by the hollow.

The phase shifter 10 according to the first embodiment has a structure such that the trench width W2 of each of the leading end portions 152 included in the respective split trenches 150 is made gradually narrower than the trench width W1 of the central part 151, so that the area of the second region 12B located between the leading end portions 152 and the heater electrode 14 is gradually wider. Then, the heater heat of the heater electrode 14 in the second region 12B is diffused, and thus, the temperature is decreased. As a result, by reducing the inclination of the temperature gradient between the bridge 12C and the second region 12B, it is possible to suppress the material of the heater electrode 14 from varying caused by thermo-migration. In addition, it is also possible to ensure long-term reliability of the phase shifter 10.

The phase shifter 10 includes the hollow portion 16 that is formed, by a hollow, on the Si substrate 11 on which the dielectric substance 12 located below the heater electrode 14 is laminated. As a result, it is possible to suppress transmission of heater heat of the heater electrode 14 to the Si substrate 11 by the hollow portion 16. Therefore, it is possible to reduce electric power consumption while improving the heating efficiency.

As compared to the first region 12A included in the dielectric substance 12 located between the central part 151 and the heater electrode 14, the leading end portions 152 are formed such that the second region 12B included in the dielectric substance 12 located between the leading end portions 152 and the heater electrode 14 is expanded. As a result, the heater heat of the heater electrode 14 is diffused in the second region 12B, and thus, the temperature is decreased.

In addition, each of the split trenches 150 according to the first embodiment is formed such that the shape of each of the leading end portions 152 has a substantially fan shape in which the trench width is made gradually narrower from the central part 151 toward each of the leading end portions 152. However, if the trench width of each of the leading end portions 152 included in the respective split trenches 150 is made narrow, an etching step is difficult at the time of manufacturing the split trenches 150, which causes degradation of a yield rate. Accordingly, in order to simplify the etching step at the time of manufacturing the split trenches 150, the shape of each of the leading end portion 152 may be formed to have the same trench width of the central part 151, and the embodiment thereof will be described below as a second embodiment.

### [b] Second Embodiment

FIG. 5 is a schematic plan view illustrating an example of a phase shifter 10A according to the second embodiment. In addition, by assigning the same reference numerals to components having the same configuration and operation as those in the phase shifter 10 according to the first embodiment, overlapped descriptions of the configuration and the operation thereof will be omitted. The phase shifter 10A illustrated in FIG. 5 is different from the phase shifter 10 in that the trench width W2 of each of leading end portions 152A included in respective split trenches 150A is made to be the same trench width W1 of the central part 151. Each of the split trenches 150A is structured to be gradually away from the heater electrode 14 in a direction from the central part 151 toward the leading end portion 152A in a state in which the trench width W2 of the leading end portion 152A is the same as the trench width W1 of the central part 151.

The second region 12B included in the dielectric substance 12 located between the leading end portions 152A included in the respective split trenches 150A and the heater electrode 14 is made greater than the first region 12A included in the dielectric substance 12 located between the central part 151 and the heater electrode 14.

In addition, each of the split trenches 150A is gradually away from the heater electrode 14 in a direction from the central part 151 toward the leading end portion 152A, the second region 12B is made greater than the first region 12A. Then, the area of the second region 12B is gradually greater. In the second region 12B, the temperature is decreased due to diffusion of the heater heat of the heater electrode 14. As a result, by reducing the inclination of the temperature gradient between the second region 12B and the bridge 12C, it is possible to suppress the material of the heater electrode 14 from varying caused by thermo-migration.

The split trenches 150A according to the second embodiment are formed such that, as compared to the first region 12A, the second region 12B is made greater in a state in which the trench width W1 of the central part 151 has the same width as the trench width W2 of the leading end portion 152A. As a result, the trench width of the central part 151 and the trench width of the leading end portion 152A have the same width, it is possible to simplify the etching step at the time of manufacturing the split trench 150A.

In addition, a case has been described as an example in which each of the split trenches 150A according to the second embodiment is made to have the shape of the leading end portions 152A illustrated in FIG. 5; however, the embodiment is not limited to this, and the embodiment thereof will be described below as a third embodiment.

### [c] Third Embodiment

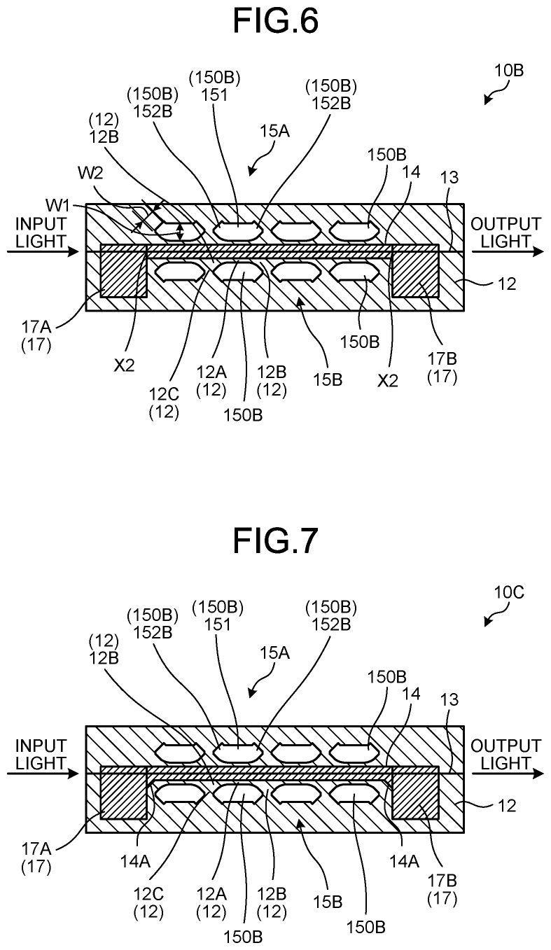

FIG. 6 is a schematic plan view illustrating an example of a phase shifter 10B according to the third embodiment. In addition, by assigning the same reference numerals to components having the same configuration and operation as those in the phase shifter 10 according to the first embodiment, overlapped descriptions of the configuration and the operation thereof will be omitted. The phase shifter 10B illustrated in FIG. 6 is different from the phase shifter 10A illustrated in FIG. 5 in that the termination of a leading end portion 152B included in a split trench 150B has a curved shape in a state in which the trench width W2 of the leading end portion 152B and the trench width W1 or the central part 151 are the same.

The second region 12B located between the leading end portion 152B and the heater electrode 14 included in each of the split trenches 150B is made wider than the first region 12A of the dielectric substance 12 located between the central part 151 and the heater electrode 14.

In addition, each of the split trenches 150B is gradually away from the heater electrode 14 in a direction from the central part 151 toward the leading end portion 152B, so that the second region 12B is made wider than the first region 12A. Furthermore, the area of the second region 12B is gradually expanded, in the second region 12B, temperature is decreased caused by diffusion of the heater heat of the heater electrode 14. As a result, by reducing the inclination of the temperature gradient between the second region 12B and the bridge 12C, it is possible to suppress the material of the heater electrode 14 from varying caused by thermo-migration.

The split trench 150B according to the third embodiment is formed such that the second region 12B is made wider than the first region 12A in a state in which trench width W1 of the central part 151 and the trench width W2 of the leading end portion 152B are not changed. As a result, the trench widths of the central part 151 and the leading end portion 152B has the same width, it is possible to simplify the etching step at the time of manufacturing the split trench 150B.

In addition, in the phase shifter 10B according to the third embodiment, temperature is sharply changed at a connecting region X2 in which the electrode pad 17 having a wide width is connected to the heater electrode 14 disposed on the optical waveguide 13 having a narrow width. Accordingly, an embodiment of solving this circumstance, and an embodiment of solving this circumstance will be described below as a second embodiment a fourth embodiment.

### [d] Fourth Embodiment

FIG. 7 is a schematic plan view illustrating an example of a phase shifter 10C according to the fourth embodiment. In addition, by assigning the same reference numerals to components having the same configuration and operation as those in the phase shifter 10B according to the third embodiment, overlapped descriptions of the configuration and the operation thereof will be omitted. The phase shifter 10C illustrated in FIG. 7 is different from the phase shifter 10B illustrated in FIG. 6 in that a joining unit 14A in which the width of the heater electrode 14 connected to the electrode pad 17 is made gradually wider from the heater electrode 14 toward the electrode pad 17 is provided in the heater electrode 14.

In the heater electrode 14, the joining unit 14A is provided in the connecting region that is connected to the input side electrode pad 17A. In addition, in the heater electrode 14, the joining unit 14A is provided in the connecting region that is connected to the output side electrode pad 17B.

The heater electrode 14 according to the fourth embodiment includes the joining unit 14A that is gradually wider toward the electrode pad 17 to which the heater electrode 14 is connected. As a result, it is possible to avoid the circumstance such as the temperature of the connecting region X2 is sharply changed in the joining unit 14A that is located between the heater electrode 14 and the electrode pad 17.

### [e] Fifth Embodiment

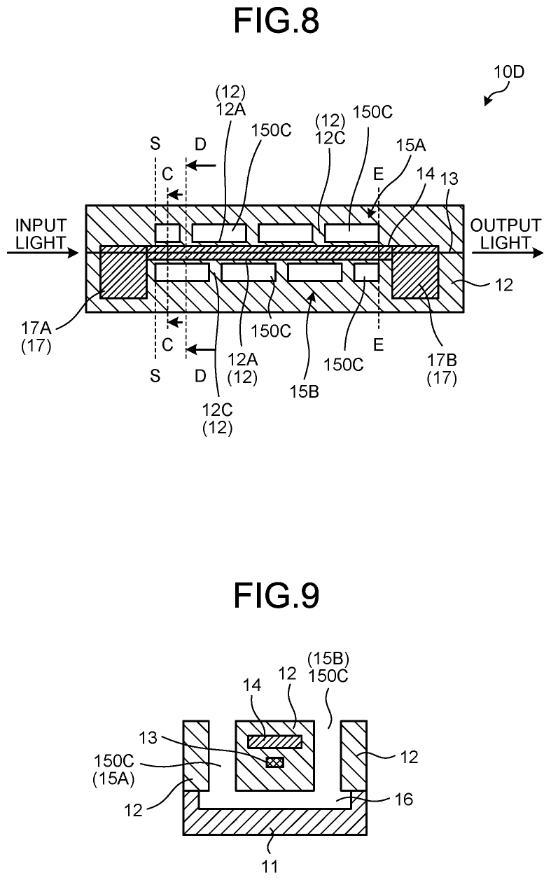

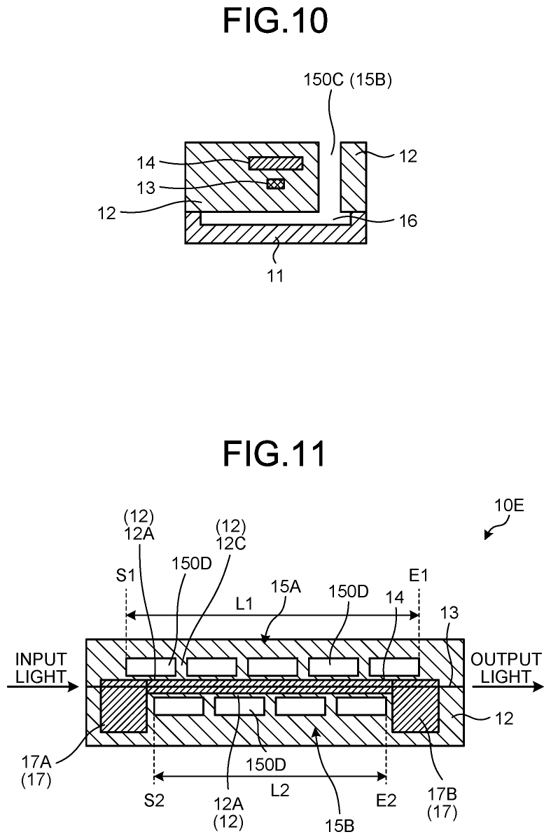

FIG. 8 is a schematic plan view illustrating an example of a phase shifter 10D according to the fifth embodiment, FIG. 9 is a schematic cross-sectional diagram taken along line C-C of the phase shifter 10D illustrated in FIG. 8, FIG. 10 is a schematic cross-sectional diagram taken along line D-D of the phase shifter 10D illustrated in FIG. 8. In addition, by assigning the same reference numerals to components having the same configuration and operation as those in the phase shifter 10 according to the first embodiment, overlapped descriptions of the configuration and the operation thereof will be omitted. The phase shifter 10D illustrated in FIG. 8 is different from the phase shifter 10 according to the first embodiment in that a pitch size and the shape of each of split trenches 150C included in the first trench 15A and the second trench 15B are different. The shape of each of the split trenches 150C is, for example, a rectangular shape. Furthermore, the number of the split trenches 150C disposed on the first trench 15A side and the number of the split trenches 150C disposed on the second trench 15B side are made to be the same.

Each of the split trenches 150C included in the first trench 15A and each of split trenches 150C included in the second trench 15B are disposed such that the bridge 12C included in the first trench 15A does not face the bridge 12C included in the second trench 15B across the heater electrode 14.

In the phase shifter 10D, a start position S of the first trench 15A and the start position S of the second trench 15B are the same based on the position of the heater electrode 14. Furthermore, in the phase shifter 10D, an end position E of the first trench 15A and the end position E of the second trench 15B are the same based on the position of the heater electrode 14.

In the phase shifter 10D, each of the split trenches 150C included in the first trench 15A and the second trench 15B is disposed such that the bridge 12C included in the first trench 15A does not face the bridge 12C included in the second trench 15B across the heater electrode 14. The bridges 12C are disposed in a distributed manner, so that the number of locations in which the heater heat generated from the heater electrode 14 is diffused is increased as compared to the phase shifter 10 according to the first embodiment. As a result, by reducing the inclination of the temperature gradient between the bridge 12C and the second region 12B, it is possible to suppress the material of the heater electrode 14 from varying caused by thermo-migration. In addition, it is possible to ensure the long-term reliability of the phase shifter 10D.

In the phase shifter 10D, the structure is formed such that the start position S of the first trench 15A and the start position S of the second trench 15B are the same based on the heater electrode 14, and furthermore, the end position E of the first trench 15A and the end position E of the second trench 15B are the same based on the heater electrode 14. As a result, it is possible to simplify the step at the time of forming the first trench 15A and the second trench 15B in the dielectric substance 12.

In addition, in the phase shifter 10D according to the fifth embodiment, a case has been described as an example in which the start positions S of the split trenches 150C included in the first trench 15A and the second trench 15B are the same, and the end positions E of the split trenches 150C included in the first trench 15A and the second trench 15B are the same. However, the embodiment is not limited to this, and the embodiment thereof will be described below as a sixth embodiment.

### [f] Sixth Embodiment

FIG. 11 is a schematic plan view illustrating an example of a phase shifter 10E according to the sixth embodiment. In addition, by assigning the same reference numerals to components having the same configuration and operation as those in the phase shifter 10D according to the fifth embodiment, overlapped descriptions of the configuration and the operation thereof will be omitted. The phase shifter 10E illustrated in FIG. 11 is different from the phase shifter 10D in that the start position S1 of a split trench 150D included in the first trench 15A is different from a start position S2 of the split trench 150D included in the second trench 15B on the basis of the position of the heater electrode 14. Furthermore, an end position E1 of the split trench 150D included in the first trench 15A is different from an end position E2 of the split trench 150D included in the second trench 15B on the basis of the position of the heater electrode 14.

In other words, in the phase shifter 10E, a first distance L1 from the start position S1 to the end position E1 of the first trench 15A is made longer than a second distance L2 from the start position S2 to the end position E2 of the second trench 15B. In addition, in the phase shifter 10E, the number of the split trenches 150D disposed in series included in the first trench 15A is different from the number of split trenches 150D disposed in series included in the second trench 15B.

Then, the split trenches 150D included in the first trench 15A and the second trench 15B are disposed such that the bridge 12C included in the first trench 15A does not face the bridge 12C included in the second trench 15B across the heater electrode 14.

In the phase shifter 10E, the input side electrode pad 17A and the output side electrode pad 17B are connected to a first side surface of the heater electrode 14, for example, the right side surface of the heater electrode 14 that is disposed in parallel with the second trench 15B. Furthermore, the first side surface of the heater electrode 14 is, for example, the right side surface.

In addition, even if the number of the split trenches 150D included in the first trench 15A is different from the number of the split trenches 150D included in the second trench 15B, the structure is formed such that the relative position of the electrode pad 17 and the split trenches 150D is the same on the input side and the output side, that is, is set to be bilaterally symmetric in the diagram illustrated in FIG. 11. As a result, by optimizing the pattern, it is possible to similarly improve a temperature distribution on the input side and the output side.

In the phase shifter 10E according to the sixth embodiment, the first distance L1 from the start position S1 to the end position E1 of the first trench 15A is made longer than the second distance L2 from the start position S2 to the end position E2 of the second trench 15B. As a result, even if the first distance L1 of the first trench 15A is different from the second distance L2 of the second trench 15B, the inclination of the temperature gradient is made to be reduced between the bridge 12C and the second region 12B. Furthermore, it is possible to suppress the material of the heater electrode 14 from varying caused by thermo-migration. In addition, it is possible to ensure the long-term reliability of the phase shifter 10E.

Furthermore, in the phase shifter 10E according to the sixth embodiment, a case has been described as an example in which the input side electrode pad 17A and the output side electrode pad 17B are disposed on the same right side surface of the heater electrode 14. However, the embodiment is not limited to the right side surface, but the structure may be applied to a left side surface, and appropriate modifications are possible. Furthermore, the input side electrode pad 17A may be disposed on the first side surface (right side surface) of the heater electrode 14, whereas an output side electrode pad 17B1 may be disposed on the left side surface that is a second side surface that is located on the opposite side of the first side surface of the heater electrode 14, and the embodiment thereof will be described below as a seventh embodiment.

### [g] Seventh Embodiment

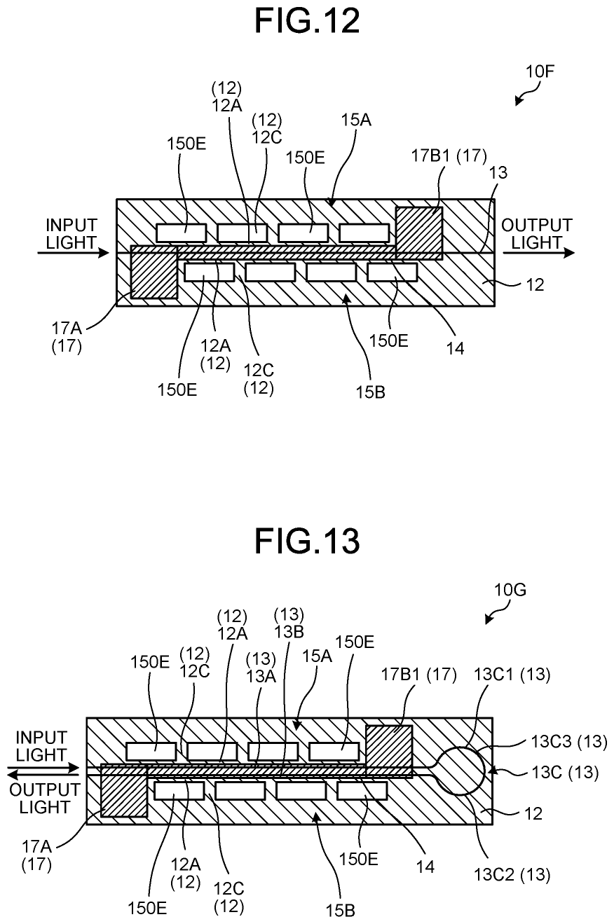

FIG. 12 is a schematic plan view illustrating an example of a phase shifter 10F according to the seventh embodiment. In addition, by assigning the same reference numerals to components having the same configuration and operation as those in the phase shifter 10E according to the sixth embodiment, overlapped descriptions of the configuration and the operation thereof will be omitted. The phase shifter 10F illustrated in FIG. 12 is different from the phase shifter 10E illustrated in FIG. 11 in that the input side electrode pad 17A is disposed on the first side surface of the heater electrode 14 and the output side electrode pad 17B1 is disposed on the second side surface of the heater electrode 14. Furthermore, if the first side surface is the right side surface of the heater electrode 14, the second side surface is the left side surface of the heater electrode 14. In other words, if the positions of the first trench 15A and the second trench 15B are different between the left and right side surfaces of the heater electrode 14, it is possible to shorten the entire length of the phase shifter 10F including the electrode pad 17.

The input side electrode pad 17A is disposed on the first side surface side of the heater electrode 14, whereas the output side electrode pad 17B1 is disposed on the second side surface side of the heater electrode 14, so that the first trench 15A is disposed on the first side surface side, whereas the second trench 15B is disposed on the second side surface side. As a result, in the phase shifter 10F, it is possible to reduce the size by an amount corresponding to the length of a single piece of the electrode pad 17 from the entire length of the phase shifter 10E.

The input side electrode pad 17A according to the seventh embodiment is connected to the first side surface of the heater electrode 14, whereas the output side electrode pad 17B1 is connected to the second side surface of the heater electrode 14. In the phase shifter 10F, it is possible to shorten the entire length of the phase shifter 10F.

In addition, a case has been described as an example in which, in the phase shifter 10F according to the seventh embodiment, the optical waveguide 13 structured in a one-way direction is disposed; however, it may be possible to dispose the optical waveguide 13 structured in a two-way direction including a returning unit, and the embodiment thereof will be described below as an eighth embodiment.

### [h] Eighth Embodiment

FIG. 13 is a schematic plan view illustrating an example of a phase shifter 10G according to the eighth embodiment. In addition, by assigning the same reference numerals to components having the same configuration and operation as those in the phase shifter 10F according to the seventh embodiment, overlapped descriptions of the configuration and the operation thereof will be omitted. The phase shifter 10G illustrated in FIG. 13 is different from the phase shifter 10F in that the optical waveguide 13 structured in a two-way direction including a returning unit 13C is disposed, and the first trench 15A and the second trench 15B are disposed on the both side surfaces of the heater electrode 14 located on the optical waveguide 13 that is structured in the two-way direction.

The two-way directional optical waveguide 13 includes an outbound side optical waveguide 13A, the returning unit 13C, and an inbound side optical waveguide 13B. The outbound side optical waveguide 13A is the optical waveguide that is connected to an input end in which signal light is input. The returning unit 13C includes a first S-shaped curve portion 13C1, a U-shaped curve portion 13C3, and a second S-shaped curve portion 13C2. The first S-shaped curve portion 13C1 is an optical waveguide that optically couples a portion between the outbound side optical waveguide 13A and the U-shaped curve portion 13C3. The U-shaped curve portion 13C3 is an optical waveguide that optically couples a portion between the first S-shaped curve portion 13C1 and the second S-shaped curve portion 13C2. The second S-shaped curve portion 13C2 is an optical waveguide that optically couples a portion between the U-shaped curve portion 13C3 and the inbound side optical waveguide 13B. Furthermore, the inbound side optical waveguide 13B is an optical waveguide that is connected to an output end and that outputs signal light received from the second S-shaped curve portion 13C2 to the output end.

The length of the outbound side optical waveguide 13A is about, for example, 10 μm to 500 μm, and the length of the inbound side optical waveguide 13B is also about, for example, 10 μm to 500 μm. Furthermore, the size of the diameter of the returning unit 13C is about, for example, 5 μm to 20 μm.

The heater electrode 14 is disposed inside the dielectric substance 12 located above the outbound side optical waveguide 13A and the inbound side optical waveguide 13B. As a result, the heater heat of the single heater electrode 14 is transmitted to the outbound side optical waveguide 13A and the inbound side optical waveguide 13B, so that the refractive index of each of the outbound side optical waveguide 13A and the inbound side optical waveguide 13B is changed.

Only with the outbound side optical waveguide 13A, the phase of the passing signal light can be shifted by 90 degrees at the maximum; however, by adding the inbound side optical waveguide 13B located after the returning unit 13C, it is possible to shift the phase of the passing signal light by 180 degrees at the maximum. As a result, it is possible to greatly reduce the electric power consumption by allowing the optical refractive index of the outbound side optical waveguide 13A and the inbound side optical waveguide 13B to be able to be changed by using a single piece of the heater electrode 14.

The first trench 15A according to the eighth embodiment is disposed in parallel with the outbound side optical waveguide 13A located below the heater electrode 14, and the second trench 15B is disposed in parallel with the inbound side optical waveguide 13B located below the heater electrode 14. As a result, it is possible to change the refractive index of each of the outbound side optical waveguide 13A and the inbound side optical waveguide 13B, so that it is possible to greatly improve the phase shift efficiency.

In addition, the outbound side optical waveguide 13A and the inbound side optical waveguide 13B are disposed below the heater electrode 14. As a result, it is possible to greatly reduce the electric power consumption by allowing the optical refractive index of each of the outbound side optical waveguide 13A and the inbound side optical waveguide 13B to be able to be changed by the single heater electrode 14.

Furthermore, a case has been described as an example in which, the phase shifter 10G according to the eighth embodiment, the returning unit 13C included in the optical waveguide 13 is disposed ahead the output side electrode pad 17B1. However, the returning unit 13C may be disposed inside the output side electrode pad 17B1, and the embodiment thereof will be described below as a ninth embodiment.

### [i] Ninth Embodiment

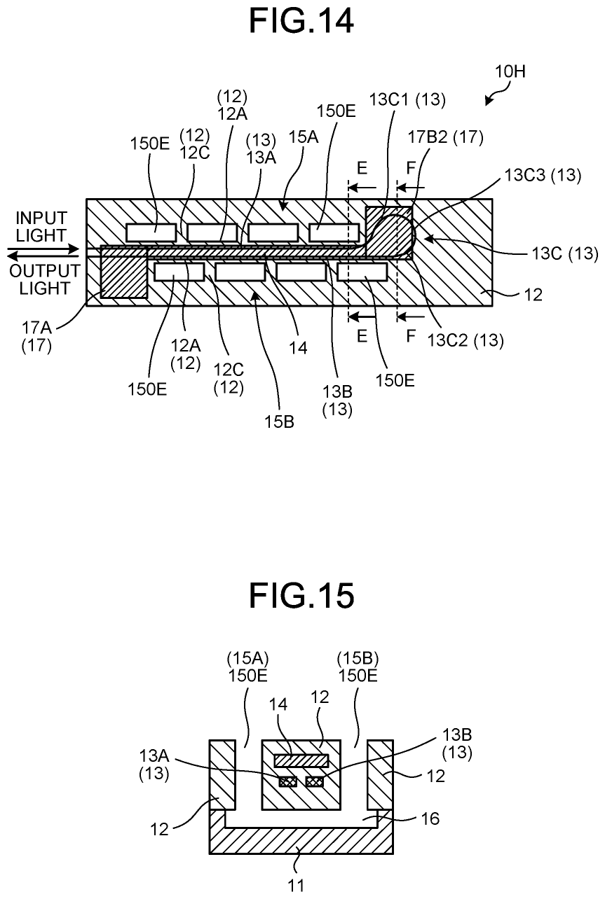

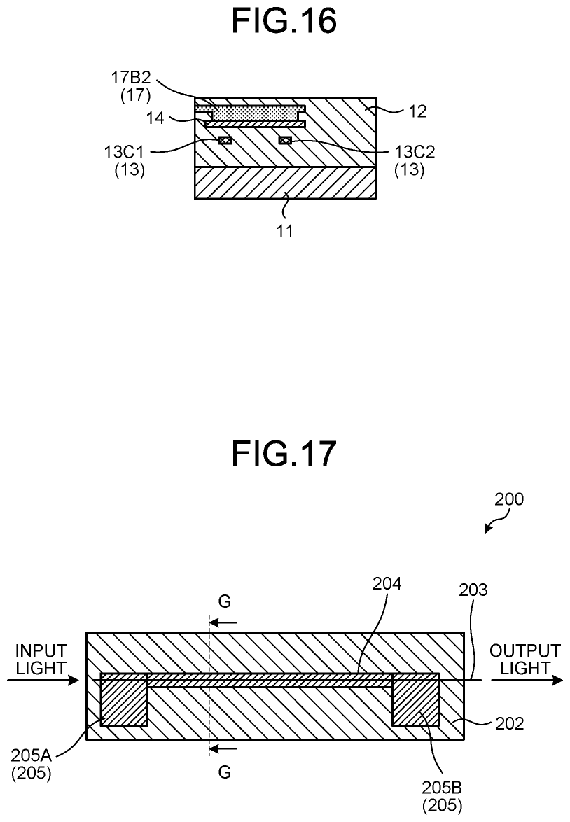

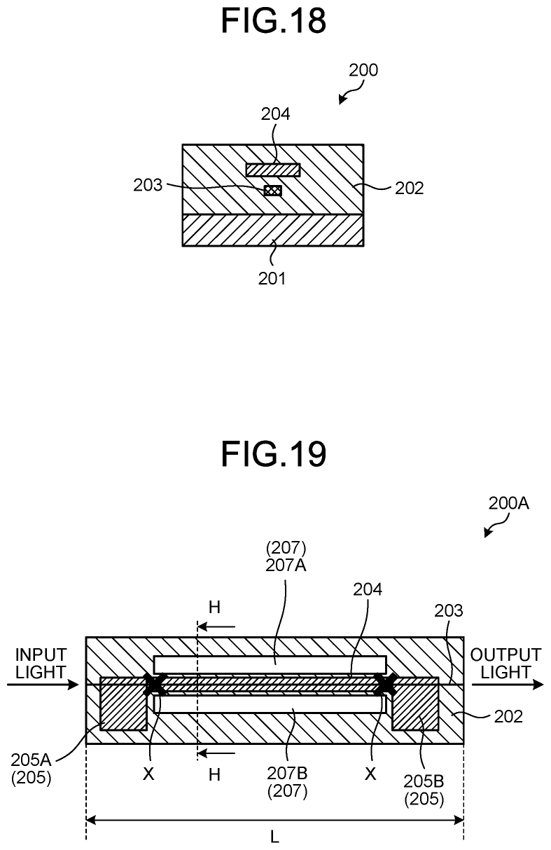

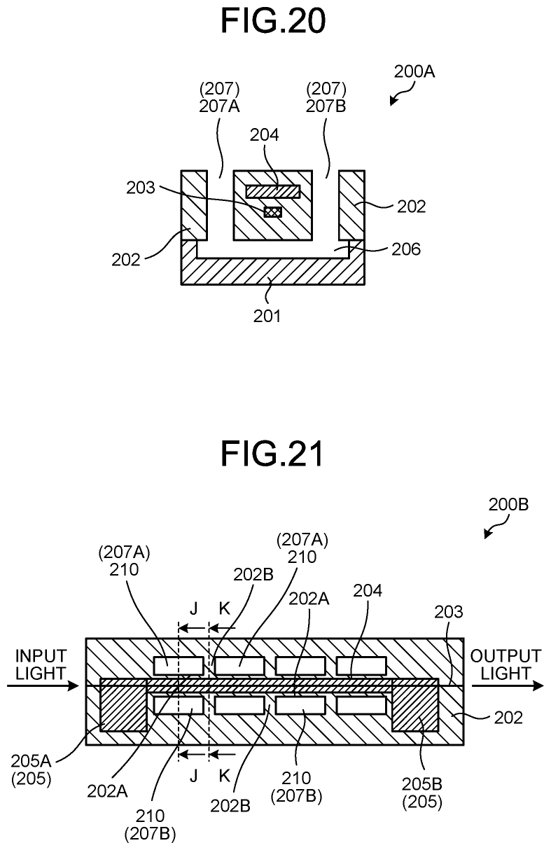

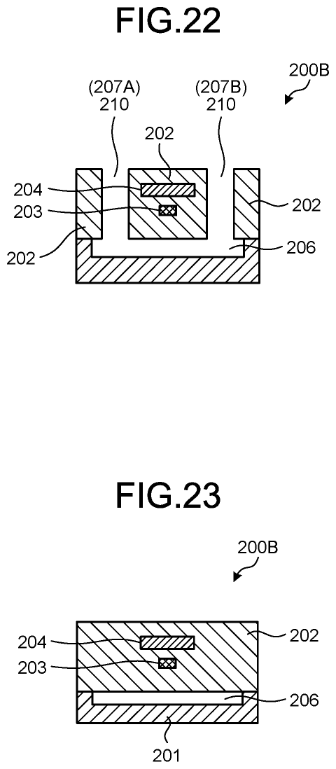

FIG. 14 is a schematic plan view illustrating an example of a phase shifter 10H according to the ninth embodiment, FIG. 15 is a schematic cross-sectional diagram taken along line E-E of the phase shifter 10H illustrated in FIG. 14, and FIG. 16 is a schematic cross-sectional diagram taken along line F-F of the phase shifter 10H illustrated in FIG. 14. In addition, by assigning the same reference numerals to components having the same configuration and operation as those in the phase shifter 10G according to the eighth embodiment, overlapped descriptions of the configuration and the operation thereof will be omitted.

The phase shifter 10H illustrated in FIG. 14 is different from the phase shifter 10G illustrated in FIG. 13 in that the returning unit 13C that joins the outbound side optical waveguide 13A and the inbound side optical waveguide 13B is disposed at the lower portion of an output side electrode pad 17B2. In the phase shifter 10H, the two optical waveguide 13, for example, the first S-shaped curve portion 13C1 and the second S-shaped curve portion 13C2, are disposed below the heater electrode 14.

The outbound side optical waveguide 13A and the inbound side optical waveguide 13B according to the ninth embodiment are disposed below the heater electrode 14, and the returning unit 13C is disposed below the output side electrode pad 17B2. As a result, even if the two-way directional optical waveguide 13 is used, the returning unit 13C is disposed below the output side electrode pad 17B2, so that it is possible to shorten the entire length of the phase shifter 10H as compared to the phase shifter 10G illustrated in FIG. 13.

In addition, in the phase shifter 10D (10E, 10G, and 10H) according to the fifth embodiment to the ninth embodiment, a case has been described as an example in which the shape of the split trenches 150C (150D and 150E) is formed in a rectangular shape; however, the embodiment is not limited to the rectangular shape, but may be formed in the shape of the split trenches 150 (150A and 150B) described in the first to the fourth embodiments, and appropriate modifications are possible.

According to an aspect of an embodiment, it is possible to ensure long-term reliability of the optical device.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a substrate;
a dielectric substance that is laminated on the substrate;
an optical waveguide that is surrounded by the dielectric substance;
a heater electrode that is disposed above the optical waveguide and that is surrounded by the dielectric substance; and
a trench that includes a plurality of split trenches, each of which is formed in a hollow segmented shape in the dielectric substance, and in which the split trenches are disposed in parallel with the heater electrode, wherein
the split trenches are disposed in parallel with the heater electrode such that an area of the dielectric substance located between an end of each of the split trenches and a side surface of the heater electrode is gradually expanded.

2. The optical device according to claim 1, further including a hollow portion that is formed in a hollow shape on the substrate on which the dielectric substance located below the heater electrode is laminated.

3. The optical device according to claim 1, wherein
each of the split trenches
includes a central part of the split trench and a leading end portion of the split trench, and
is formed such that a second region of the dielectric substance located between the leading end portion and the side surface of the heater electrode is expanded larger than a first region of the dielectric substance located between the central part and the side surface of the heater electrode.

4. The optical device according to claim 3, wherein each of the split trenches is formed such that the second region is expanded larger than the first region in a state in which a trench width of the central part is made to be the same as a trench width of the leading end portion.

5. The optical device according to claim 3, wherein
the trench includes
a first trench that is disposed parallel to one of side surfaces of the optical waveguide,
a second trench that is disposed parallel to the other of the side surfaces of the optical waveguide,
a first bridge that couples the plurality of split trenches that are disposed in series in the first trench, and
a second bridge that couples the plurality of split trenches that are disposed in series in the second trench.

6. The optical device according to claim 3, wherein the heater electrode includes, in a region that is connected to an electrode pad, a joining unit that is gradually expanded from the heater electrode toward the electrode pad.

7. An optical device comprising:
a substrate;
a dielectric substance that is laminated on the substrate;
an optical waveguide that is surrounded by the dielectric substance;
a heater electrode that is disposed above the optical waveguide and that is surrounded by the dielectric substance; and
a trench that includes a plurality of split trenches, each of which is formed in a hollow segmented shape in the dielectric substance, and in which the split trenches are disposed in parallel with the heater electrode, wherein
the trench includes
a first trench that is disposed parallel to one of side surfaces of the optical waveguide,
a second trench that is disposed parallel to the other of the side surfaces of the optical waveguide,
a first bridge that couples the plurality of split trenches that are disposed in series in the first trench, and
a second bridge that couples the plurality of split trenches that are disposed in series in the second trench, and
the split trenches included in the first trench and the split trenches included in the second trench are disposed such that the first bridge does not face the second bridge across the heater electrode.

8. The optical device according to claim 7, wherein the split trenches included in the first trench and the split trenches included in the second trench are disposed such that a start position at which disposition of the first trench in parallel with the heater electrode is started is the same as a start position at which disposition of the second trench is started, and such that an end position at which disposition of the first trench disposed in parallel with the heater electrode is ended is the same as an end position at which disposition of the second trench is ended.

9. The optical device according to claim 7, wherein the number of the split trenches that are disposed in series in the first trench is different from the number of the split trenches that are disposed in series in the second trench.

10. The optical device according to claim 9, wherein the split trenches included in the first trench are disposed in series and the split trenches included in the second trench are disposed in series such that a first distance between a first start position at which disposition of the first trench is started and a first end position at which disposition of the first trench is ended is made longer than a second distance between a second start position at which disposition of the second trench is started and a second end position at which disposition of the second trench is ended.

11. The optical device according to claim 7, further including:
an input side electrode pad that is connected to the heater electrode and that inputs an electric current to the heater electrode; and
an output side electrode pad that is connected to the heater electrode and that outputs the electric current from the heater electrode, wherein
the input side electrode pad is connected to one of side surfaces of the heater electrode, and
the output side electrode pad is connected to the other of the side surfaces of the heater electrode.

12. The optical device according to claim 11, wherein
the optical waveguide includes
an outbound side optical waveguide,
an inbound side optical waveguide, and
a returning unit in which the outbound side optical waveguide is optically coupled to the inbound side optical waveguide,
the first trench is disposed in parallel with the outbound side optical waveguide, and
the second trench is disposed in parallel with the inbound side optical waveguide.

13. The optical device according to claim 12, wherein
the outbound side optical waveguide and the inbound side optical waveguide are disposed below the heater electrode, and
the returning unit is disposed below the output side electrode pad.

14. An optical communication apparatus comprising:
a processor that executes signal processing on an electrical signal;
a light source that emits light; and
an optical modulator that modulates, by using the electrical signal output from the processor, the light emitted from the light source, wherein
a phase shifter included in the optical modulator includes
a substrate,
a dielectric substance that is laminated on the substrate,
an optical waveguide that is surrounded by the dielectric substance,
a heater electrode that is disposed above the optical waveguide and that is surrounded by the dielectric substance, and
a trench that includes a plurality of split trenches, each of which is formed in a hollow segmented shape in the dielectric substance, and in which the split trenches are disposed in parallel with the heater electrode, and
the split trench are disposed in parallel with the heater electrode such that an area of the dielectric substance located between an end of each of the split trench and a side surface of the heater electrode is gradually expanded.

15. An optical communication apparatus comprising:
a light source that emits light; and
an optical receiver that demodulates a reception optical signal by using the light received from the light source, wherein
a phase shifter included in the optical receiver includes
a substrate,
a dielectric substance that is laminated on the substrate,
an optical waveguide that is surrounded by the dielectric substance,
a heater electrode that is disposed above the optical waveguide and that is surrounded by the dielectric substance, and
a trench that includes a plurality of split trenches, each of which is formed in a hollow segmented shape in the dielectric substance, and in which the split trenches are disposed in parallel with the heater electrode, and
the split trench are disposed in parallel with the heater electrode such that an area of the dielectric substance located between an end of each of the split trench and a side surface of the heater electrode is gradually expanded.
